(19) United States
(12) Patent Application Publication
(10) Pub. No.: US 2007/0156774 A1
(43) Pub. Date: Jul. 5, 2007

(54) Multi-Tier Document Management System

(75) Inventor: David Gomes, Los Angeles, CA (US)

Correspondence Address: MCDERMOTT WILL & EMERY LLP, Suite 3400, 2049 Century Park East, Los Angeles, CA, 90067, US

(73) Assignee: Integrated Data Corporation

(21) Appl. No.: 11/687,524

(22) Filed: Mar. 16, 2007

Related U.S. Application Data
(63) Continuation of application No. 10/807,032, filed on Mar. 23, 2004, now abandoned.

(51) Int. Cl. G06F 17/30

(52) U.S. Cl. 707/200

(57) ABSTRACT

A multi-tier document management system is disclosed wherein a data repository (DR) tier includes a master data repository for storing a centralized body of data. A data replication store (DRS) tier includes one or more data units for storing subsets of the data from the master repository that are relevant to the needs of the end users of the data units. A data management component (DMC) tier mediates between the data repository (DR) tier and data replication store (DRS) tier, allowing for configuration management and for performing synchronization of data. The data management component (DMC) tier may also include a configuration manager for mapping data sets to applicable end users. One or more external interfaces may be provided to the end users or customers for interfacing with the various tiers.

### CROSS-REFERENCE TO RELATED APPLICATION

This United States patent application claims priority to and is a continuation of U.S. application Ser. No. 10/807,032, filed Mar. 23, 2004, entitled “Multi-Tier Document Management System,” attorney docket no. 66470-011. This United States patent application is also related to U.S. application Ser. No. 10/987,373, entitled “Smart and Selective Synchronization Between Databases in a Document Management System,” filed Nov. 12, 2004, attorney docket no. 66470-013. The contents of both of these applications are incorporated herein by reference.

### BACKGROUND OF THE INVENTION

1. Field of the Invention

The present invention relates generally to document management, and more specifically to a multi-tier document management system.

2. Description of Related Art

The proliferation of document revision systems has soared in recent years. Document management systems generally provide a centralized repository for a related group of users to create and edit a relevant body of documentation. Such an example would include a corporation with multiple locations working on common document types. Typical document systems enable multiple users to “work” on a related set of documents, and save the updates or revisions. Such document systems generally utilize networking capabilities for expanded functionality and simultaneous accessibility by multiple users. Updated documents are available at various locations. These systems ordinarily include a centralized location where the server computer (or array of computers) is located. The server, or set of servers, often contain a sophisticated array of memory banks in which to house the various documents. Users at remote locations can access and, assuming they have applicable permissions, can edit and update the documents. The updated documents are usually stored in the central repository. The array of servers typically forms one logical entity, even though a number of networked memory banks may be involved.

Various problems exist with respect to the existing state of the art. One example relates to the unidirectional capabilities of existing document management systems. In particular, document revisions can be transmitted to a central location, but synchronization generally cannot be performed centrally, with the results transmitted to the remote location. At the remote location, synchronization and critical revisions may be necessary but unavailable.

Another problem in the art relates to user access. Because only a centralized repository and a set of remote sites exist, no independent mechanism is available for managing user profiles. As an illustration, different users may be relegated with different permissions. In the case of a sensitive military operation, for example, certain users may have clearance to access sensitive documents while other users (for security or other reasons) may not have the same permissions. No integrated, independent mechanism currently exists for controlling and maintaining user profiles in a low or high bandwidth environment. As a result, user permissions must be assigned at the central location, which may result in confusion, multiple users controlling access, and, in the end, potentially fatal errors in document management and security. Using current software, it is difficult, if not impossible, to maintain coherent user profile permissions for different classes of users. In short, no satisfactory documented configuration management system exists.

The movement of data—documents and otherwise—presents an equal challenge with respect to current systems. The initiation of document transfers must occur either at the centralized repository or the remote location. In either case, it is difficult for the system to keep track of the multiple document transfers by multiple end users. Data movement can be sporadic with inadequate records available to a user for tracking data transfer. There exists little to no integration of document transfer history, resulting in challenges for information technology personnel.

A need exists in the art for a robust and integrated document management system which, among other attributes, provides a centralized and coherent mechanism for controlling document-based operations.

### SUMMARY OF INVENTION

In one aspect of the present invention, a document management system includes: an intelligent data repository component including a logical master repository for storing data; a data replication component including one or more local data units for storing data sets, each data set originating at least in part from the data in the logical master repository and including information applicable to a corresponding one of the local data units; and a data management component (knowledge data management component (DMC)) including a configuration manager for mapping the data sets to end users of the local data units, a knowledge manager for identifying the data sets, and a synchronization service for transferring updated data from the logical master repository to the one or more local data units.

In another aspect of the present invention, a three-tier document management system for use by an entity including a plurality of end user groups includes: a data repository (DR) tier including a content management system for storing data in a master repository; a data replication store (DRS) tier including a plurality of data units which correspond respectively to each of the plurality of end user groups; and a data management component (DMC) tier for managing the end user profiles and for mediating the synchronization of data between the data repository (DR) tier and the data replication store (DRS) tier.

In still another aspect of the invention, a document management system for managing the storage and transfer of data includes: data repository (DR) means for providing a master data repository for storing and managing data; data replication store (DRS) means for providing one or more data units, each data unit for storing information originating at least in part from the data in the master data repository; and data management component (DMC) means for maintaining records relevant to a state of each of the one or more data units and for synchronizing the data in the data repository (DR) means with the information in the one or more data units in the data replication store (DRS) means.

Other embodiments of the present invention will become readily apparent to those skilled in the art from the following detailed description, wherein it is shown and described only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is an illustration of a multi-tier document management system in accordance with an embodiment of the present invention.

FIG. 2 is an illustration of a multi-tier document management system in accordance with another embodiment of the present invention.

FIG. 3 shows an example of a user search engine web interface in accordance with an embodiment of the present invention.

FIG. 4 is a an example of a user interface in accordance with an embodiment of the present invention.

FIG. 5 is an example of a user interface for facilitating the manual synchronization of documents in accordance with an embodiment of the present invention.

FIG. 6 is an example of a web-based user interface that provides a login screen in accordance with an embodiment of the present invention.

FIG. 7 is an example of a web-based user interface for providing information regarding the document management system in accordance with an embodiment of the invention.

### DETAILED DESCRIPTION OF ILLUSTRATIVE EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention.

The software platform as disclosed herein may enable one or more users to tailor, maintain, and distribute various data types (including sensitive or secret data) to and from a centralized repository and various remote data units. In one embodiment, the platform of the present invention is designed to provide uniform content management, document versioning, knowledge distribution to specified users, and digital content manipulation. The platform can be constructed as a series of layered software routines. The platform provides a standardized document and control system that allows for the manipulation of formats and controlled distribution of data. The platform also may feature an advanced content management and control system architecture that allows for manipulation of data at the sub-document or information object level.

The enterprise solution according to the present invention includes a multi-tier configuration. The platform includes a knowledge “data management component (DMC)” between the end user and the master repository, or the various other user repositories. Among other attributes, the data management component (DMC) enables an administrator to build, construct, and maintain indices to the data in the master repository and/or the data units. The data management component (DMC) may assemble a user digital technical data library collection (or update to an existing library) based on chosen data objects, and the needs and permissions of the user can be identified by a predefined user profile. The data management component (DMC) can then transmit this collection of technical data (or updates) to the user site as necessary or appropriate. The user can access a web-based or other portal to access this data. The portal management system may provide a common user interface that dynamically produces updates and management functions to personalize the data dictated by the user profile. Moreover, the platform in certain configurations may permit a local line management in a particular unit or corporation to manage and modify selected components of the portal interface. In one embodiment, a user-friendly document viewer displays documents, regardless of format, in a standard template. The template allows, among other benefits, standardized document searches. The portal in this implementation also provides drop-down menus for associated checklists generated by the entity. A frame for the user's further customization of the platform may also be provided.

Generally, document management is a complex subject covering the complete lifecycle of a document including its creation, edition, updates, revision management, viewing, and obsolescence. A document management system and method according to the present invention is divided into multiple tiers of cooperating components. This division enables more intelligent data flow and control, more centralized management of user profiles for sensitive or complex applications, and greater efficiency in day-to-day operations.

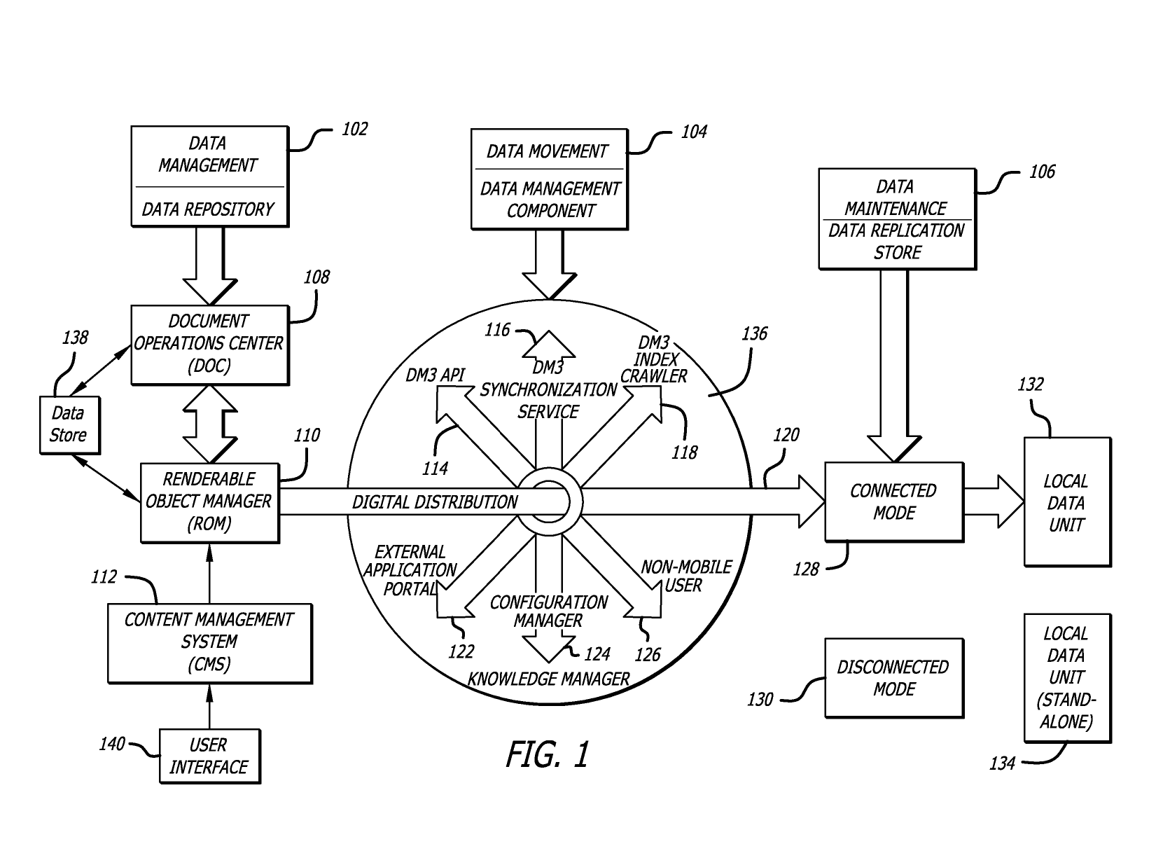

FIG. 1 is an illustration of a multi-tier document management system according to an embodiment of the present invention. The system in FIG. 1 includes three principal tiers: (i) the data management (data repository (DR)) tier 102; (ii) the data movement (data management component (DMC)) tier 104; and (iii) the data maintenance (data replication store (DRS)) tier 106. The data management tier 102 maintains one or a plurality of databases which generally constitute a centralized repository for the data pertinent to a particular customer, such as a corporation, partnership, government agency, military entity, etc. The data management tier 102 includes a master document repository including, in one embodiment, a document operations center 108, renderable object manager 110, content management system 112, and data store 138. The data store 138 constitutes the primary repository for all data and control information needed to populate the end-user digital libraries.

As illustrated below, the specific hardware requirements of the data store are generally dependent upon the needs of the customer and the application(s) at issue. Data store 138 is ordinarily redundant in nature, and includes protection from memory or hardware faults. Data store 138 is also referred to as a logical master repository or data repository (DR). The data repository (DR) maintains the centralized sets and families of data for a particular customer, keeping track of the revision history of documents.

The content management system 112 generally controls access to the data store 138. While seen as a separate component in this example, the content management system 112 may include or encompass part or all of the functionality of other blocks, such as the renderable object manager 110 and the document operations center 108. Data and/or document revisions, insertions, additions, updates, deletions, removals, etc., may be handled through the content management system 112. In some implementations, the content management system 112 may be coupled to a user interface 140 such as a web service. The web service may have a published markup language that can be used by the customer for interfacing with the data store 138. As discussed further below, communication with the content management system 112 can occur locally, or over a TCP/IP network. Through the vehicle of the content management system 112, documents can be added to or removed from data store 138, and searches can be performed based on various criteria input by the user or by an application. In some embodiments, the user interface may be considered to be a part of the renderable object manager 110. In other configurations, different types of user interface capabilities may be included within the different software layers.

A document operations center 108 may also be included which allows for the manipulation of documents within data store 138. The document operations center 108 is generally intended to encompass a wide range of capabilities for manipulating or modifying data contained in the data store 138. Many of these capabilities are dependent upon the applications and needs of the customer. In general, revisions may be updated, and revision histories may be maintained or controlled within this entity. A search engine and indexing functionality may also be provided in document operations center 108. Renderable object manager (ROM) 110 provides data to data store 138 and mediates between the data management tier 102 and the data movement tier 104. ROM 110 may include an indexer, user interface, or data provider interface for transmitting data from an external source to data store 138. ROM 110 may allow a user to enter data into the data store 138 through the content management system 112. ROM 110 also may provide a pipe 120 for the distribution of digital data through a data management component (DMC) tier 104 to a data replication store (DRS) tier 106.

In some configurations, the content management system 112 may generally include the functionality of the renderable object manager 110 and the document operations center 108. Further, in some embodiments, data from the data replication store (DRS) tiers 106 may be sent via the data management component (DMC) tier 104 up to the data store 138 for storage, as through pipe 120 or through another mechanism.

One objective of the data management tier 102 is to ensure that the latest updated relevant information is timely provided to the end user. Accordingly, the data management tier 102 may include: capabilities for document management such as creation, updates, deletes, revisions, etc.; one or more document search engines for accessing the data in master repository 138 and for identifying documents based on key words or phrases; identifying document applicability to users based on appropriate roles and permissions (as defined or maintained in some embodiments in the data management component (DMC) tier 104); maintaining document security by requiring digital certificates, authentication, encryption, or other means; allowing manual or automatic updates to information in master repository 138 through content management system 112 and user interface 140; handling disparate document types; optimizing bandwidth in the case of synchronizations; providing document access at all times; providing flexibility in document revision management schemes; and maintaining document sets and inter-related families.

A data movement or data management component (DMC) tier 104 is also provided. For clarification, the data management component (DMC) tier 104 is distinct from the data management tier 102. In one embodiment, the data management component (DMC) tier 104 (as exemplified by the functionality and components set forth in knowledge manager 136) mediates between the data repository environment tier 102 containing the master repository (i.e., data store 138 and associated interfacing tools) on one hand, and the data replication tiers 106 on the other hand. More specifically, the data management component (DMC) tier 104 manages the end user sites (e.g., local data unit 132) in accordance with changes received from the data repository (DR) tier 102. The data management component (DMC) tier 104 includes a DM3 synchronization service 116 which may be coupled through a network or other intermediary mechanism to the data repository (DR) tier 102 and one or more data replication store (DRS) tiers 106. The DM3 synchronization service may perform and manage changes at the byte-level and may also perform automatic synchronizations of data according to a particular configuration management solution. In turn, data can be synchronized only to networks or data replication store (DRS) tiers 106 that require the data, thereby potentially saving significant bandwidths over systems that simply transmit synchronization information to all connected data units. For the purposes of this disclosure, the term “DM3” generally refers to actions performed for or on behalf of (but not necessarily by) the data maintenance or data replication store (DRS) tier 106. For example, because synchronization is a process which provides updates contained in data store 138 to data units 132 in data replication store (DRS) tier 106, the synchronization service according to this embodiment is considered a DM3 synchronization service 116.

As can be seen from FIG. 1, the data management component (DMC) environment 104 may include several individual services that collectively provide an overall knowledge management function. These functions may be separate entities, but they generally are built on software layers designed to function together in order to perform the necessary tasks of the data management component (DMC) 104.

Data management component (DMC) environment tier 104 includes in one embodiment a knowledge manager layer 136. The knowledge manager 136 is associated with two major functions that, in some configurations, work in conjunction with one another. A Global Knowledge Manager (GKM) (not shown) installs at a base location and is administrated by the base command, and a Local Knowledge Manager (not shown) installs at a unit location. The GKM and LKM, described in greater detail below, may be very close organizationally and physically to the operational units. Generally, the LKM permits local modification of the digital library by the unit. The GKM may constitute a parent node, upon which the LKM child node depends to determine the latest data available for the unit.

As noted above, the knowledge manager 136 includes a synchronization service 116. The synchronization service performs data synchronization between the GKM and the LKM and the GKM and the data repository (DR). In some configurations, the synchronization service 116 identifies the applicable LKM (and corresponding unit) by its profile. Based on this profile, the synchronization service identifies the applicable documents, renderable objects and database records necessary to make a complete digital library for the LKM to be synchronized. The synchronization service is discussed in greater detail, below.

The knowledge manager 136 also includes a configuration manager 124. The configuration manager constitutes a collection of software routines that is responsible for identifying the data applicable to a specific end user in the retail environment 106. A hashed mapping may be maintained between data sets and end users. The configuration manager 124 may reference this mapping when identifying applicable data sets. As discussed below, the configuration manager 124 may in one embodiment be accessible through a web service. Access to the configuration manager 124 can be made through an administration user interface, or directly through the web service interface.

The knowledge manager 136 also may include a DM3 index crawler 118. In some implementations, the index crawler constitutes a software-based service that identifies the current location and revision of the data managed by the knowledge manager 136. For example, the synchronization service 116 may monitor all data relevant to a profile at a particular user site and then use the index crawler 118 functionality to identify and synchronize any data being added, modified or deleted at the data store associated with the user site at issue. The knowledge manager 136 may also include a DM3 API 114. The API (application programming interface) 114 provides a defined interface so that other programs, such as third party programs used by the customer, can access the capabilities of the knowledge manager 136. The API 114 provides user-friendly access by the customer to the various attributes and capabilities associated with the knowledge manager 136. Similarly, an external application portal 122 and a non-mobile user interface 126 may provide users with the ability to communicate with the knowledge manager 136. In one embodiment, all data accessed through the external application portal 122 is located at its original distribution point, such as, for example, a SAN data store or command specific information located locally at the knowledge manager 136 site. The external application portal 122 (or, in some embodiments, the API 114 and/or non-mobile user interface 126) provides for the use of pre-designated profiles and may allow the end-users to customize their profiles to gain access to various portions of the data managed by the knowledge manager 136. Accordingly, users can access data based on their specific needs.

The data replication store (DRS) tier 106 may include a local version of the global components associated with knowledge manager 136. These local components may include a local knowledge manager, local content manager, local search engine, local synchronization service, local configuration manager service, local knowledge manager administrator's workstation, and local user interface. Each of these components associated with the data replication store (DRS) tier 106 is discussed in greater detail, below. Generally, the retail environment 106 constitutes the set of physical and logical functionality associated with a local data unit 132 or 134. A general collection of all applicable data may be maintained by the data management tier 102. Different local data units in the data maintenance or data replication store (DRS) tier 106 may be populated with different data sets, depending on factors such as the type of deployment associated with the data unit 132, and needs and permissions of the users at the data unit 132. User profiles can be maintained using the functionality associated with the data management component (DMC) tier 104. The transfer of updated documents and data from the data repository (DR) tier 102 and the data replication store (DRS) tier 106 can be mediated by the functionality of the data management component (DMC) 104 and the knowledge manager 136. That is, synchronizations can be performed for individual data units using information controlled by the administrator(s) of the data management component (DMC) tier. In this manner, specific data units need only obtain synchronized data relating to that specific unit. In addition, the data replication store (DRS) tier 106 can use the local knowledge manager and search engine functionality to perform searches and obtain data relating to other applications and other units (provided user profiles allow for such searches and data accesses). Manipulation of user profiles or of profiles of specific data units can be performed using the tools associated with the knowledge manager.

In the illustration of FIG. 1, the data replication store (DRS) tier 106 can operate in either a connected mode 128 or a disconnected mode 130. These modes are explained in greater detail below. In general, when the local data unit 132 is in connected mode 128, the local knowledge manager component of the local data unit 132 is connected to the global network (and hence the wholesale environment 102). During this period, the local data unit 132 may be in an active state of synchronization with the data store 138, and users at the local data unit 132 can perform searches or obtain the most updated documents in near real time. In disconnected mode 130, a local data unit effectively functions as a stand-alone unit 134. In this mode, all data comes from the data unit itself (rather than from the master repository, i.e., the data store 138), which data is current as of the last synchronization session with the knowledge manager 136 or through updates obtained using other media.

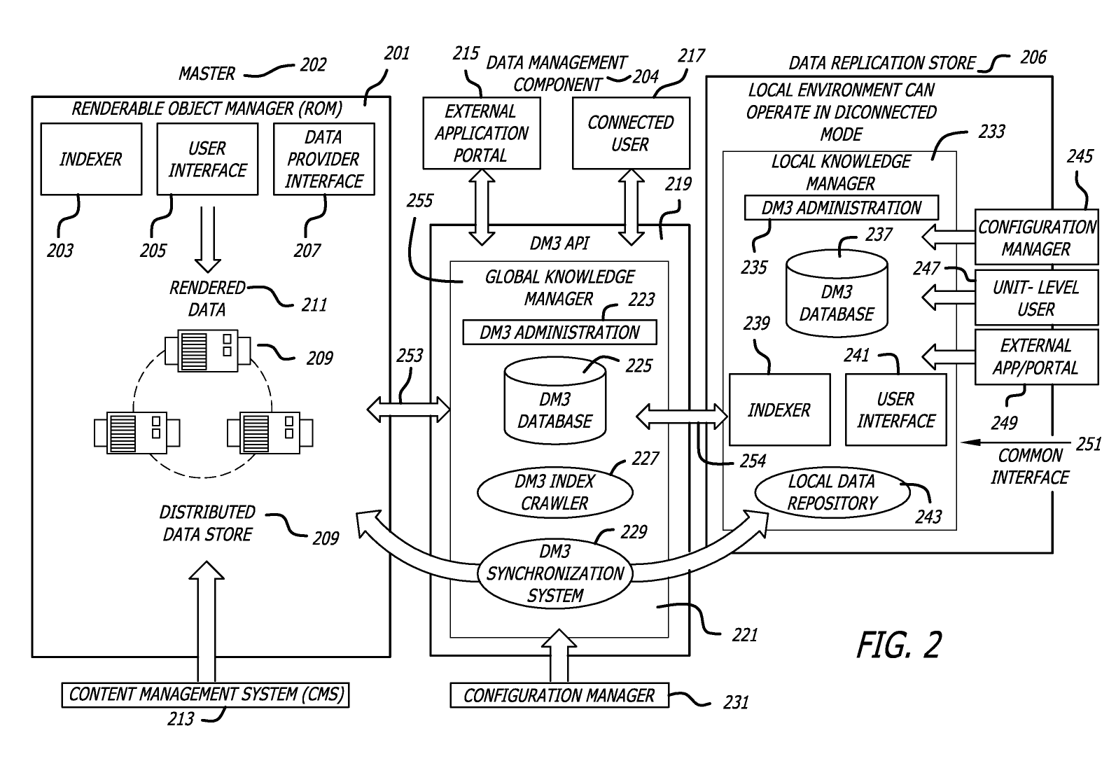

FIG. 2 is an illustration of a multi-tier document management system in accordance with another embodiment of the present invention. The master repository (corresponding to data repository (DR) tier) 202 is shown, along with the data management component (DMC) tier 204 and data replication store (DRS) tier 206. The master repository includes a content management system 213 which may include a number of subsystem components for facilitating the storage, addition, removal, and updating of data stored in the master repository 202. For example, a renderable object manager (ROM) 201 may include an indexer 203, user interface 205, and data provider interface 207. The ROM 201 may generally include a multi-layer software solution for controlling the flow of data into the master repository 202. An indexer 203 may be used to identify the current location and revision of data stored in the master repository 202. In other configurations, indexer 203 may be used to keep track of the revision history of documents, or to categorize documents according to certain criteria applicable to a customer. A user interface 205 may provide an administrator or other individual with access to the master repository 202 for maintenance and administration purposes, or to perform searches, etc. A data provider interface 207 may provide a vehicle for a customer or other entity to input data into the master repository, either automatically through a series of executable routines, or manually. Data input into the master repository 202 results in rendered data 211 that generally is placed into an array of physical memory devices such as the distributed data store 209. In general, while the master repository 202 may be considered as a single logical entity, the distributed data store 209 may be segmented into multiple physical structures such as SANs or RAID arrays, etc.

Mediating between the master 202 and data replication store (DRS) 206 is the data management component (DMC) 204, in this illustration through logical link 253 from the master 202 to the global knowledge manager 255. As indicated previously, the global knowledge manager 255 generally installs at a base location (typically in proximity to or at the same location as the master 202) and is administrated by a central “command” as governed by the structure, attributes and requirements of the customer entity. As is shown in this illustration, the capabilities of the global knowledge manager 255 may be exploited via the DM3 application programming interface (API) which provides a uniform interface structure and a set of commands for performing various functions and services within the global knowledge manager.

The data management component (DMC) tier 204 includes a configuration manager 231, which is a collection of software routines responsible for identifying within the master repository 202 a specific collection of data that is applicable to a given data unit within the data replication store (DRS) 206. As noted, the configuration manager 231 typically accomplishes this identification procedure by maintaining a mapping between data sets and different end users. DM3 administration component 223 may include a series of routines for administrating the data management component (DMC) and for making amendments to user profiles, permissions, authentication procedures, the applicability of data sets, etc. Information pertaining to data management component (DMC) administration may be stored in DM3 database 225, accessible to an administrator via the global knowledge manager 255 and a user interface 215 or 217, or DM3 API 219.

DM3 index crawler 227 may be used to identify the current location and revision of data managed by the global knowledge manager 255 or local knowledge manager 233. Access to the index crawler functionality 227 by the local knowledge manager entity in the data replication store (DRS) tier 206 may be accomplished via logical link 254 and DM3 API 219. The two logical links 253 and 254 may be any known network connection, or in some instances (such as where the data management component (DMC) 204 functionality resides at the master 202) a network connection may not be required. DM3 synchronization service 229 also resides within data management component (DMC) tier 204 and may be used to synchronize data between the distributed data store 209 of master tier 202 and a local data repository 243 associated with data replication store (DRS) tier 206, in a manner described in this disclosure.

User access to the functionality of the data management component (DMC) tier 204 may also be accomplished through a direct user interface in which a connected user 217 has access, or through an external application portal 215 for use by third party applications, such as applications specific to the customer.

A data replication store (DRS) tier 206 is also shown in FIG. 2 which discloses a local knowledge manager 233. In this configuration, the local knowledge manager 233 resides at the unit location and permits, among other functions, local modification by a user of the information in local data repository 243. As in this illustration, the global knowledge manager 255 remains the “parent node” even though the local knowledge manager 233 can operate independently, such as in situations when it is disconnected from the global knowledge manager 255.

The local knowledge manager 233 in this embodiment includes capabilities that essentially mirror the capabilities of the global knowledge manager 255. Similar components include: a DM3 administration component 235 used for a system administrator of the local unit; a DM3 database for storing data used by the local knowledge manager 233 such as data pertaining to authentication, user profiles, etc.; an indexer 239 for indexing the data or keeping track of revision histories in local data repository 243; a user interface 241 for allowing a user at the local unit access to the data in the local data repository (as limited by the applicable permissions and profile of the user); and a configuration manager 245 for identifying data sets applicable to specific users (for example, when in disconnected mode). In the illustration shown, a unit-level user 247 is accessing the local data repository 243 using the local knowledge manager 233 and user interface 241. Further included is a portal for external applications, which provides an interface for a user's third party applications designed to operate in conjunction with the local data repository 243 and local knowledge manager 233. A common interface 251 may provide an API containing a series of commands or procedures of the local knowledge manager 233 that are accessible to the user.

Below, the three tiers of various embodiments of the document management system are set forth in greater detail.

Logical Master (Data Repository (DR)) Repository—Data Management

In one embodiment, a logical master repository stores all documents and revisions. The master repository maintains sets and families of documents, keeping track of the revision history of documents. The master repository in one implementation is a single logical entity; however, the repository can consist of multiple physical entities. By way of example, a RAID-based array of disks can be spread across a number of computers for storing the data. In addition, one of the various networks of physical data storage techniques can be used to implement the master repository. In other embodiments, the data from the master repository is located in a single physical entity.

In certain circumstances, the master repository may also serve as a “remote” database for an end user to search and view. An appropriate search engine may be employed for the end user to conduct searches and identify the latest document revisions.

The master repository includes a data store, which may constitute the primary repository for all data and control information necessary to populate the end-user digital libraries. The specific hardware requirements of the data store (e.g., a storage area network, simple RAID array, etc.) are dependent on the applications and needs of end users. Again, however, the data store is typically redundant in nature and able to sustain single hardware component failures without data loss or significant downtime.

The master repository in certain implementations also includes a content manager. The content manager controls all access to the data store. In one embodiment, the content manager includes a web service with a published interface language (e.g., WSDL) that can be used by end users for interfacing. A customizable client may also be provided to the end users for controlling the content manager.

Communication with the content manager may occur locally, or over a network such as a TCP/IP network using HTTP or HTTPS protocols with different levels of authentication ranging from a simple “user ID/password” mechanism to server/client authentication using digital certificates, the latter vehicle typically being employed for particularly sensitive applications.

The content manager may provide, in various embodiments, one or more of the following capabilities:
(1) List all documents located in the data store or repositories thereof;
(2) Search for documents and/or retrieve documents in the data store based on some match criteria input by a user or program;
(3) Add new or revised documents to the data store; or
(4) Remove documents or versions from the data store based on some match or other criteria from an end user or application.

In one embodiment, an exemplary WSDL interface may be tailored to provide a suitable web interface to these capabilities. WSDL is an XML format language for describing network services as a set of endpoints operating on messages containing either document-oriented or procedure-oriented information. The operations and messages using WSDL are generally described abstractly, and then bound to a concrete network protocol and message format to define an endpoint. Related concrete endpoints may be combined into abstract endpoints, often referred to as services. While other languages can be used, WSDL is extensible to allow description of endpoints and their messages regardless of what message formats or network protocols are used to communicate. For example, WSDL may be used in conjunction with (among other protocols) SOAP 1.1, HTTP GET/POST, and MIME.

The logical master repository may also include one or more search engines for enabling searches by keywords, title, document identifying attributes, revision, author, and other meta data. In one embodiment, the search engine is highly customizable and can easily be adapted to search against customer defined data. A single term or a phrase may be used for search purposes. In other embodiments, multiple terms may be combined together with Boolean operators to form a more complex query or query set. The search engine in some configurations supports single and multiple character wildcard searches. In addition, the search engine may support fuzzy searches based on the Levenshtein Distance or Edit Distance algorithms. The search engine may also allow range queries and proximity searches. The searches can also be grouped.

The logical master repository also includes a synchronization mechanism which, in one embodiment, interfaces with a synchronization mechanism in the data management component (DMC) to provide for the synchronization of data between a user site and the logical master repository.

In many embodiments, data transfers between the data repository (DR) and external entities attempt to take advantage of existing data sets and versioning information. This technique may allow for very efficient bandwidth utilization and much faster updates. Updates to the data store of the master repository over a network transfer, in one embodiment, include only the changed bytes of data instead of complete data sets when loading data from a user site.

In addition, the logical master repository according to some configuration may include a mechanism for redundancy to protect faults like system crashes or defective hardware. Conventional storage arrays and networks may be used for this purpose. While in one embodiment the logical master repository includes a single logical instance, the master repository is scalable and can also consist of multiple physical redundant systems for failover and load balancing purposes.

Knowledge Data Management Component (DMC)—Data Movement

In one aspect of the present invention, a knowledge data management component (DMC) is employed as described above. The knowledge data management component (DMC) may be a logical entity which is comprised of several individual services that function together to create an overall knowledge management function. In one embodiment, these functions are considered separate entities; however they generally should be capable of communicating with one another in order to provide an end user with an integrated data system with multiple capabilities. The knowledge data management component (DMC) may include: an overall knowledge manager that identifies the user and knows where the applicable data that the particular user needs is located; a user interface web page that facilitates the communication of the appropriate information to and from the knowledge data management component (DMC); an index crawler service that may identify the current location and revision of the data managed by the knowledge data management component (DMC); a configuration manager that provides the knowledge data management component (DMC) with the ability to identify which data is applicable to a specific user; and a synchronization service that maintains the local data sets with the most current data available.

An overall knowledge manager in some embodiments has two major implementations working in conjunction with each other. A Global Knowledge Manager (GKM) may be installed at a base or central location and is administrated by a base command (such as in the case of a military application). A Local Knowledge Manager (LKM) may be at the end user location. In some instances, the LKM permits local modification of the digital library by the end user. The GKM and LKM may work in conjunction with one another, as described above, to provide an integrated set of data management and movement capabilities to the central location and an end user's location. The GKM may be the parent node for the knowledge manager and each LKM installation may constitute a child node that, depending on the application, may be able to operate independently (disconnected) from the parent node. Even in this latter situation, the child node still relies on the parent node to determine criteria including the latest data available for the node.

A knowledge manager administration user interface may enable remote administration of the configuration manager and streamlined maintenance of user profiles.

A synchronization service within the knowledge data management component (DMC) may perform data synchronization between the GKM and the LKM, and between either the GKM or LKM and the logical master repository. The synchronization service may identify the LKM by attributes contained within its profile. Based on the profile, the synchronization service may identify the applicable documents, renderable objects (ROs) and database records necessary to make a complete digital library for the specific LKM. The synchronization service may identify the applicable library by communicating with the configuration manager and GKM, and then doing a comparison of the identified library with the current data set under control by the LKM. The synchronization service then locates and transfers all necessary documents, ROs, knowledge manager database records and configuration manager database records to the LKM performing the applicable add, modify or delete actions necessary to consummate the process and completely synchronize the LKM's data library with the applicable library identified by the GKM.

In one embodiment, only the data applicable to the identified profiles will be synchronized. Additionally, only the modified data transfers between the FKM and the LKM, i.e., the incremental update technology or byte level synchronization, is employed. If the GKM's identified data already matches the LKM's data, the synchronization service need not transfer the data. The synchronization service also reports all actions to both the GKM and LKM administrators, so that each entity is kept updated with respect to synchronization actions that may have been performed.

In some implementations, the synchronization service is capable of operating in a continuous mode with synchronization actions being performed on a predefined schedule based on systems settings controlled by either the LKM or GKM administrators. The settings established by the GKM ordinarily take precedence over the LKM. While in continuous mode, the synchronization service may monitor all data applicable to a particular user profile and, with the help of an index crawler or other application, the synchronization service may identify and synchronize any data required to be added, modified, or deleted at the predefined data stores (e.g., located at a user site). Once data is updated at one of the data stores pursuant to this process, the synchronization service may automatically synchronize the LKM's data library.

In other configurations, the synchronization service is also capable of operating in both a “push” and “pull” mode, meaning that data can be transferred in either direction (towards the master repository or towards an end user site). The mode in one embodiment is determined by the users, rather than the technology or application. Either the LKM or GKM administrator has the ability to initiate the manual execution of the synchronization service.

A local synchronization service may also be present for operating in standalone mode. This mode may occur, for example, when the unit constituting a user site is not connected via a network or otherwise to the logical master repository, but still may receive data through some form of transportable media (e.g., CD-ROM, DVD, etc.) from an outside organization through one of the official distribution channels. An illustrative scenario involving the use of this service may be where an end user site is located on a ship or aircraft, and a long deployment occurs wherein the unit is unable to connect to the GKM and perform an online synchronization procedure. While in this manual mode, the local administrator may place the newly provided data from the transportable medium onto a predefined location of a local network to which the end user's repository is coupled. Thereupon, the local synchronization service, with the possible assistance from a local index crawler, local configuration manager or other application(s), can identify the necessary undated or new data on the medium and synchronize the new data with the existing local data set.

The data management component (DMC) may also include a configuration manager. The configuration manager constitutes the entity responsible for identifying the data applicable to a specific end user. The configuration manager in one embodiment maintains a hashed mapping between data sets and end users. It provides an external interface to manage different user configurations based on different input criteria. The input criteria is customizable to the specific needs of end users, and is limited by their applicable permissions as defined in their respective user profiles.

As an illustration, in a sensitive military application, the configuration manager may employ a web-based messaging system which is capable of identifying and returning data describing the technical documentation to an applicable individual class of ships or aircrafts to an external application. The technical documentation may also relate to multiple classes of ships or aircrafts, an individual ship or aircraft, or multiple ships or aircrafts. The identified data may contain the appropriate revisions/changes, if any, applicable to the requested unit. The configuration manager is capable of returning data sets that include large amounts of configuration data such as technical manuals, checklists and drawings applicable to a specific device, aircraft, ship, etc. The configuration manager may return the change or revision of a specific technical manual, checklist, drawing, etc., based on the technical document number and its applicable unit.

In one embodiment, the configuration manager includes a web service that typically runs “behind the scenes.” The configuration manager is coupled to a database through intermediary layers of software, and provides a user interface to an end user for manipulating and moving data and other functions as described herein.

In another aspect, a suitable application programming interface (API) or web-services interfaces provides a common interface structure so that other programs can seamlessly access the functionality of the knowledge manager. The API interface may be made available for the ease of use of third party applications and will describe the methods and attributes of the knowledge manager.

In addition, in some embodiments, a web portal-type interface (“data management component (DMC) user interface”) may provide users with the ability to communicate with the GKM. Data accessed through the data management component (DMC) user interface is generally located at its original distribution point, such as the Joint Computer-Assisted Logistics System (JCALS) SAN data store or command specific information located locally at the GKM's site. The data management component (DMC) user interface permits the use of predefined profiles or permits end-users in certain circumstances to customize their profiles to gain access to all or a portion of the data managed by the knowledge data management component (DMC). This capability allows users access to filtered or unfiltered data based on specific needs and limited, if applicable, by governing permissions, the latter of which may be overseen by another entity.

An illustration in a navy environment relates to a shipyard worker who is primarily interested in data related to a specific type of submarine. Initially, the user may select a predefined profile for that submarine. However, the next day the shipyard worker may need information directed to high-pressure air compressors. In that case, the worker may need to search the entire knowledge store at the master repository for this information. The data management component (DMC) user interface allows an unfiltered search for the data to find the largest data set available. Additionally, the shipyard worker may want to create a custom profile to narrow the amount of data to a specific area of interest but still provide access to a larger portion of the data store when compared to a predefined profile.

In another embodiment, the data management component (DMC) layer allows for the caching of data that commonly may be read to or written from local libraries. Thus, data that is most commonly transferred may reside in a repository controlled by the data management component (DMC) software layer and accessible by a user site. This caching capability enables the data management component (DMC) to establish a connection with a user site and provide information much more quickly than where the information is located in the master repository. This caching mechanism can also be used for data transferred in the other direction—namely, from user sites to the master repository.

Local (Data Replication Store (DRS)) Environment—Data Maintenance

The local or data replication store (DRS) environment manages one or more repositories for maintaining data locally at designated user sites. In one embodiment, the data replication store (DRS) also provides a web-based user interface to control various actions. Typically, a single data replication store (DRS) handles multiple end users. Each user is differentiated based on a user profile which is used to control the user's access to documents.

In some embodiments, the local environment is operable in two modes. A connected mode is used when the LKM component of the digital library is connected to the global network—such as, in the illustration using the navy, when the ship is in port—and in communication with the GKM. During the connected period, the local digital library (that is, the information residing in the user data unit) is in a state of synchronization between the LKM and GKM. Local users still can access the required data from the local data store, rather than the logical master repository. In one embodiment, it is the responsibility of the synchronization service (whether automatic or manual) to ensure that local users have the ability to view the most up to date data available. Additionally, in the connected mode, local users with appropriate permissions will be able to access information directly through the GKM interface to the supplier network, including the master repository. This latter situation may arise when a local user needs to view data not directly applicable to his or her local site. For example, if the local site resides on a military aircraft, and the local user is part of a unit that needs access to information regarding another aircraft or an issue not directly pertinent to the aircraft, the user may access the master repository for this information.

The disconnected mode usually occurs when the local user site or unit does not have the means to communicate with the GKM. The example described above is when a local site resides in a seacraft which is not in port and not connected to the GKM using the required networking mechanism. While in disconnected mode, all data generally comes from the local data store. This data is current as of the last synchronization session with the GKM or via other updates (such as CD-ROM, etc.)

In some implementations, the LKM component is a mobile piece of software that installs at the unit level. The LKM may deploy with the unit and can function separately from the total system (such as, for example, in disconnected mode). In general, the functionality available to the data management component (DMC) environment (GKM) replicates at the data replication store (DRS) environment (LKM) because the data replication store (DRS) environment may have the capability to operate in disconnected mode.

A local content manager may be used in still other embodiments. The content manager may control all access to the local data store. The content manager transparently connects to the data repository (DR) document store (master repository) as necessary in connected mode. In embodiments using internet-based protocols, access may be permitted through the local user interface using HTTP or HTTPS protocols with different levels of authentication ranging from simple user-ID/password control to server and client authentication using digital certificates.

The local content manager may provide some or all of the following capabilities:
(1) List all documents in the document store;
(2) Search for documents in the document store based on some match criteria;
(3) Retrieve documents from the document store based on some match criteria;
(4) Add new or updated documents to the document store;
(5) Remove documents from the document store based on some match criteria.

The data store can be updated through data management component (DMC) synchronization requests and/or through local or remote client utilities. In addition, new documents added to the local store can be “reverse-synchronized” to the master repository by the GKM administrator.

The data replication store (DRS) environment may also include a local search engine. The local search engine enables searches by keywords, title, document ID, revision, author, and any defined meta data. The search engine is highly customizable and can be easily adapted to search against customer or user defined data. A single term or a phrase can be used, for example, for search purposes. Multiple terms can be combined together with Boolean operators to form a more complex query. The search engine may support single and multiple character wildcard searches. The search engine may also support fuzzy searches based on various algorithms, and may allow range queries and proximity searches. The searches can also be grouped.

A local synchronization service may also be utilized within the data replication store (DRS) environment. The service is utilized when the unit is not connected to the base but still receives data from an outside organization through one of the official or recognized distribution channels. One possible illustration involving the use of the local synchronization service is a long deployment when the unit is unable to connect to the data management component (DMC) and perform online synchronization. While in manual mode, the local administrator may place the newly provided data (from any media such as CD-ROM, DVD, magnetic tape, etc.) into a predefined or designated location on the local network used by the data replication store (DRS). The local synchronization service (in some instances with the help of the local configuration manager described below) may identify the necessary data in the update and synchronize the new data with the existing local data set.

In addition, a local configuration manager service may be used in the data replication store (DRS) environment to identify which data is applicable to a specific command, unit, or user. In some implementations, this service constitutes a back-up component that enables disaster recovery in the disconnected mode. Prior to disconnecting, the data replication store (DRS) unit should have all information associated with the deploying equipment via the data management component (DMC). However, the local configuration manager may enable the local administrator to configure the system for disaster recovery.

In one embodiment, a local component of the LKM administrator's workstation function is made available to the manager of a data replication store (DRS) site to accommodate functions associated with remote administration. Some or all of the following administration functions may be included:
(1) Global synchronization setup (connected mode)
(2) Local synchronization setup (disconnected mode)
(3) Local configuration manager setup
(4) Local data store updates
(5) User profile maintenance

A local user interface may also be provided. For example, a web page may be used to provide local users with the ability to communicate with the LKM. In some implementations, all data accessed through the local user interface will be located on the network. In other implementations, the local user interface may also allow users to access information related to other pieces of equipment, ships, or units while in connected mode.

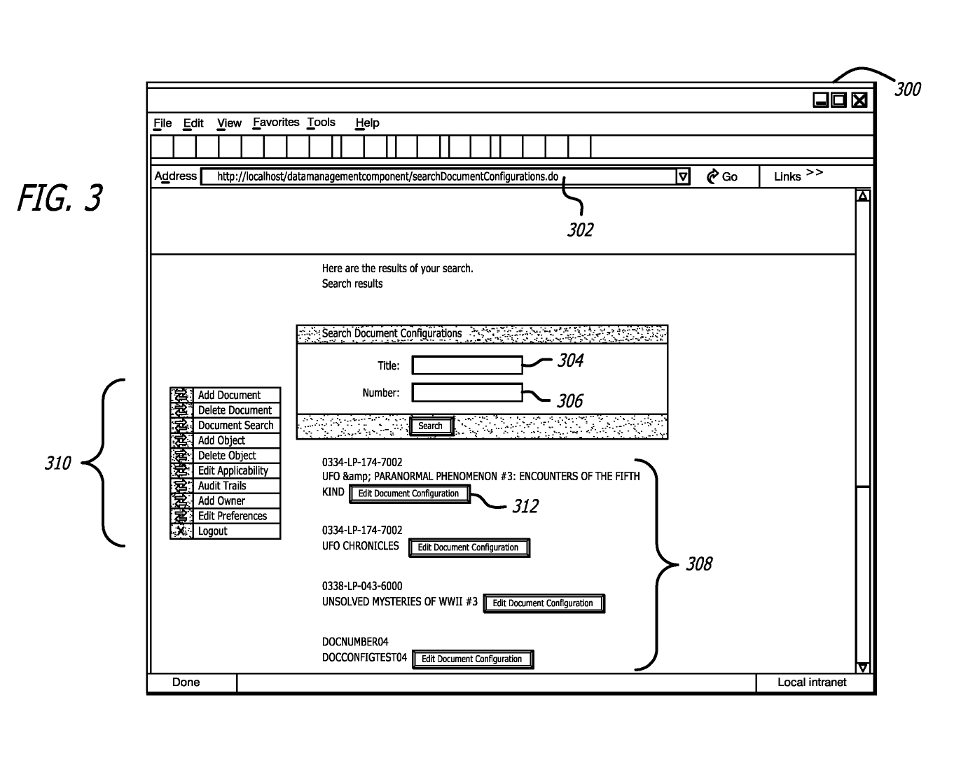

FIG. 3 shows an example of a user search engine web interface page 300 in accordance with an embodiment of the present invention. The user interface 300 is in a web-based, user friendly format, and provides a vehicle for access to the capabilities of a local knowledge manager at a local data unit. A user may navigate to a particular page using conventional web-based techniques, as shown by uniform resource locator 302. In this example http is used, although https may be used in more sensitive applications. In still other applications, such as applications where greater security is provided, another type of user interface may be more appropriate. Accordingly, different types of user interfaces may be used without departing from the spirit or scope of the present invention.

The search engine in FIG. 3 allows a user at a remote site to enter a document title (box 304) or document number (box 306) to access a document, or body of documents of interest. A list of results 308 may appear in which the identity of the document at issue as well as other possible options (including an edit document configuration option 312) may be available. In addition, the user interface 300 includes a collection links 310 which may encompass a drop down menu for adding and deleting various documents or objects, for editing user preferences, or for performing various administrative functions.

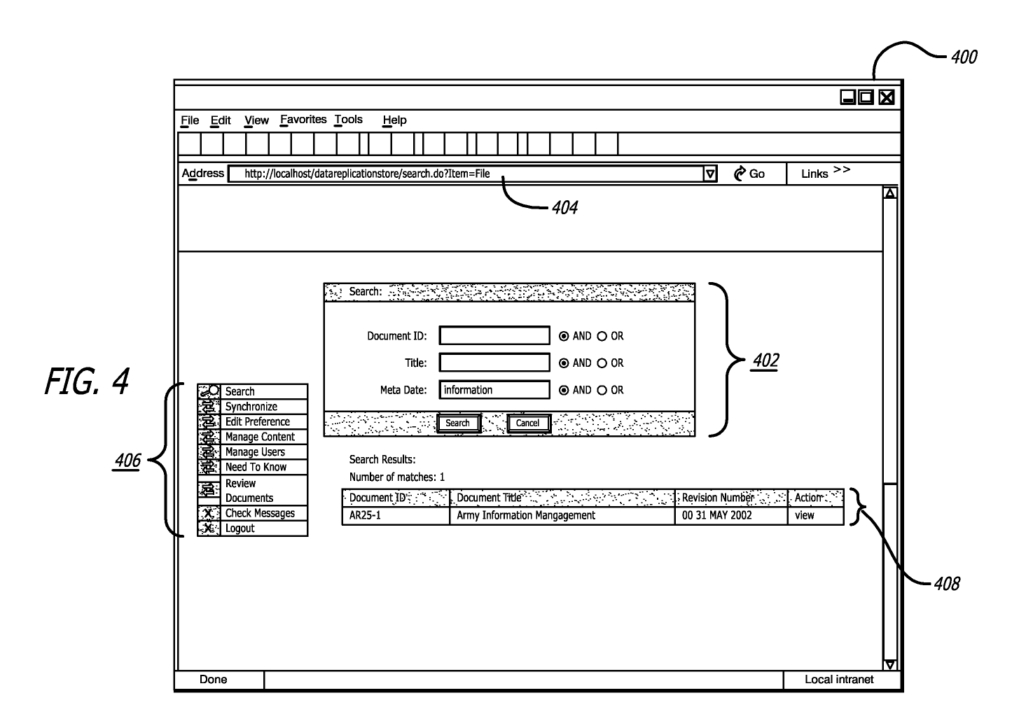

FIG. 4 is another example of a web-based user interface 400 in accordance with an embodiment of the present invention. The interface 400 may be suitable for a system administrator, as illustrated by the links 406. An administrator can manage the accessibility of various content to specific users, or can designate certain documents “need to know”, etc. The interface 400 also provides a search engine 402 which enables searches based on Document ID, Title, and Meta Data, all including Boolean operator functionality. In this example, the results of a search are displayed in a template 408 beneath the search input template 402.

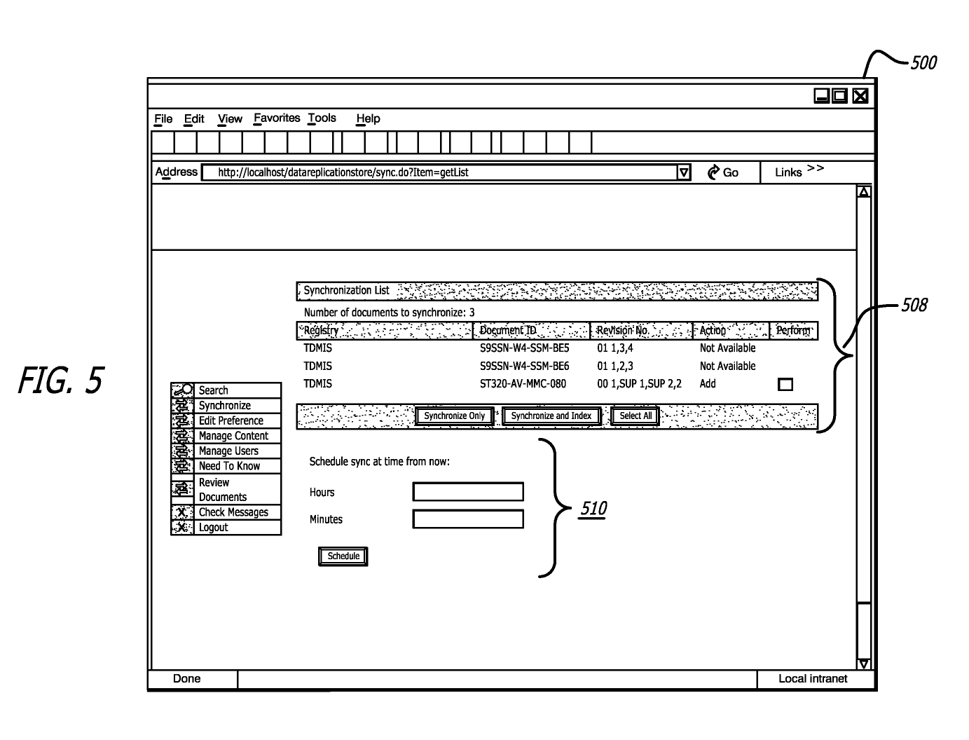

FIG. 5 is an example of a user interface 500 for facilitating the manual synchronization of documents in accordance with an embodiment of the present invention. As noted above, synchronization can occur both automatically or in a manual mode depending on the configuration. In this example, a synchronization template is provided which lists the specific documents which a user wishes to synchronize with the master repository. The user has the option to synchronize one or more of the documents, or to synchronize and index the documents as shown in template 508. Template 510 provides for an additional option to schedule the synchronization of the data to a certain time.

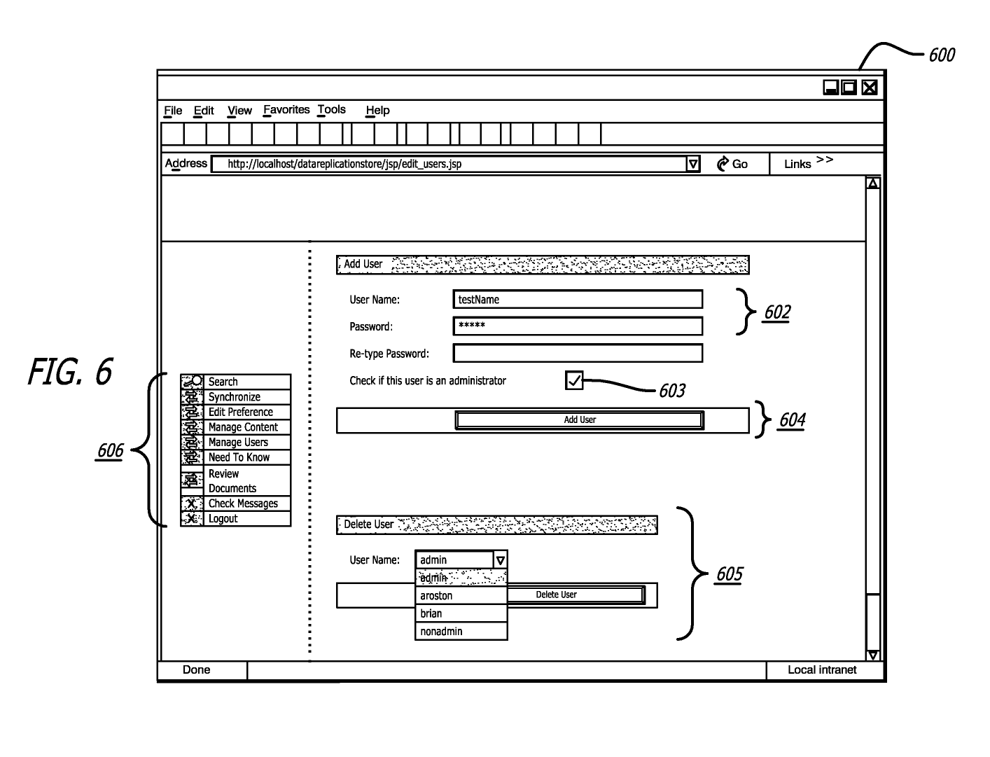

FIG. 6 is an example of a web-based user interface 600 that provides a login screen in accordance with an embodiment of the present invention. A template 602 provides a standard mechanism for a user to log onto the system. As shown in 603, the system can determine whether the user is an administrator, in which case certain additional privileges may be accorded that individual. For example, where the user is an administrator, the user may be able to add additional users as in 604, to delete users as in 605, or to manage or change the various permissions of users as described in the various options associated with links 606.

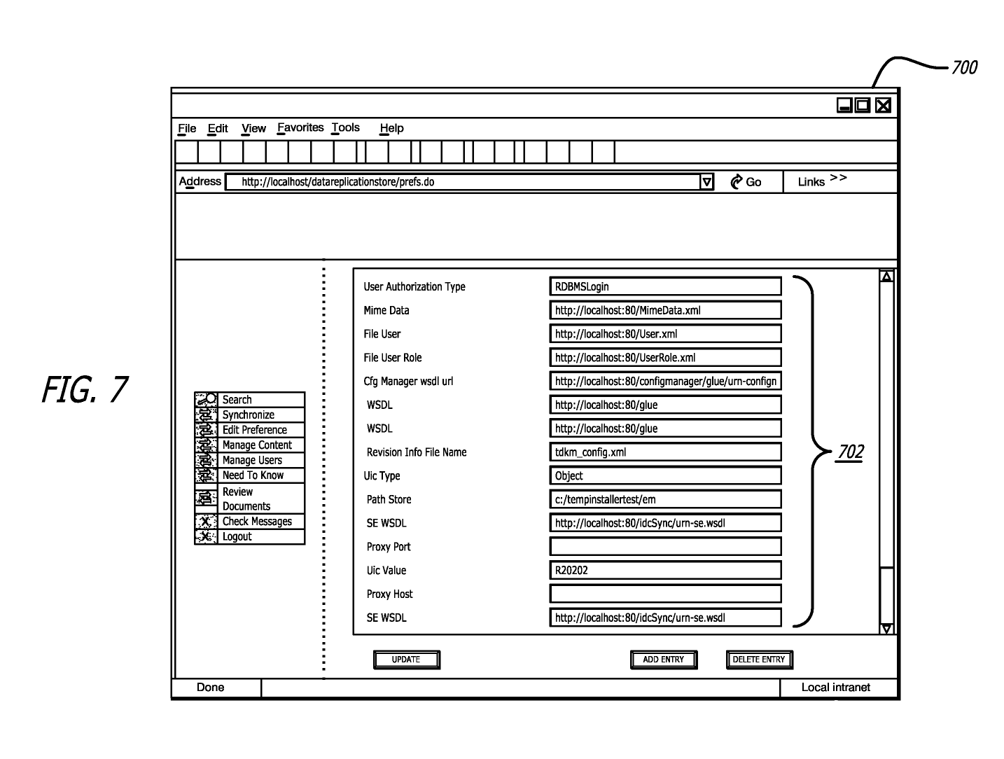

FIG. 7 is an example of a web-based user interface 700 for providing information regarding various aspects of the system. Template 702, for example, provides a user with information relating to various roles of the data management component (DMC) and data replication store (DRS) as well as their respective URLs. Additional details relating to the configuration of the system (such as the WSDL and port locations) are provided. Using the web-based interface, a user at a local unit can have broad and seamless access to cross-navigational links which can provide an efficient way to obtain necessary information quickly. It will be appreciated that these user interfaces are illustrative in nature, and that significant modifications or departures from these examples can be made without departing from the scope of the present invention.

The GKM may operate as a primary user interface portal for integration of other systems, it may also “snap in” to existing systems and rely on those system's user management functions, such as profiles, to filter the information to a specific topic or user. The portal may provide a web-based interface that presents information in a format to which users are already accustomed and allow users at all levels to simultaneously access the system using a standard web browser or other interface.

A MIME mapping may be used to map document types to native document viewers. The appropriate native viewer may then be launched whenever viewing a document. The user interface may allow for customization based on user needs.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A document management system comprising:
(i) a data repository (DR) component comprising a logical master repository for storing data;
(ii) a data replication store (DRS) component comprising one or more local data units for storing data sets, each data set originating at least in part from the data in the logical master repository and comprising information applicable to a corresponding one of the local data units; and
(iii) a data management component (DMC) component comprising
(a) a configuration manager for mapping the data sets to end users of the local data units,
(b) a knowledge manager for identifying the data sets, and
(c) a binary synchronization service for transferring updated data from the master repository to the one or more local data units.

2. The document management system of claim 1 wherein the knowledge manager further comprises a global knowledge manager and a local knowledge manager.

3. The document management system of claim 1 wherein the knowledge manager further comprises a user interface to enable access by one of the end users.

4. The document management system of claim 1 wherein the knowledge manager further comprises an application programming interface to enable access to the knowledge manager by application programs.

5. The document management system of claim 1 wherein the data repository (DR) component further comprises a renderable object manager.

6. The document management system of claim 1 wherein the data repository (DR) component further comprises a content management system.

7. The document management system of claim 1 wherein the data repository (DR) component further comprises a user interface.

8. The document management system of claim 1 wherein the data management component (DMC) further comprises an index crawler.

9. The document management system of claim 1 wherein the knowledge manager further comprises an application programming interface (API) for permitting access by third party applications.

10. The document management system of claim 1 wherein the knowledge manager is coupled to a distribution network for distributing the updated data.

11. The document management system of claim 1 wherein the data replication store (DRS) component further comprises a connected mode coupling at least one of the data units to the data management component (DMC).

12. The document management system of claim 1 wherein at least one of the data units operates in disconnected mode.

13. The document management system of claim 1 wherein the knowledge manager further comprises an external application portal.

14. A three-tier document management system for use by an entity comprising a plurality of end user groups, the system comprising:
a data repository (DR) tier comprising a content management system for storing data in a master repository;
a data replication store (DRS) tier comprising a plurality of data units which correspond respectively to each of the plurality of end user groups; and
a data management component (DMC) tier for managing the end user profiles and for mediating the synchronization of data between the data repository (DR) tier and the data replication store (DRS) tier.

15. The document management system of claim 14 wherein the data management component (DMC) tier further comprises a data repository for storing cached data applicable to one or more of the plurality of data units.

16. The document management system of claim 14 further comprising a global knowledge manager for accessing services in the master repository.

17. The document management system of claim 16 further comprising a local knowledge manager for accessing services in at least one of the plurality of data units.

18. The document management system of claim 14 wherein the data repository (DR) tier is coupled to the data replication store (DRS) tier through a distribution channel.

19. The document management system of claim 18 wherein the distribution channel is coupled to the data management component (DMC) tier.

20. The document management system of claim 19 wherein the data management component (DMC) tier further comprises a synchronization service coupled to the distribution channel for performing data synchronization between the data repository (DR) tier and the data replication store (DRS) tier.

21. The document management system of claim 20 wherein the synchronization service is bidirectional.

22. The document management system of claim 14 wherein user profiles of the plurality of end users in the groups are created at the data management component (DMC) tier.

23. A document management system for managing the storage and transfer of data comprising:
data repository (DR) means for providing a master data repository for storing and managing data;
data replication store (DRS) means for providing one or more data units, each data unit for storing information originating at least in part from the data in the master data repository; and
data management component (DMC) means for maintaining records relevant to a state of each of the one or more data units and for synchronizing the data in the data repository (DR) means with the information in the one or more data units in the data replication store (DRS) means.

24. The document management system of claim 23 wherein the data management component (DMC) means further comprises a configuration manager for mapping data sets to end users of the data units.

25. The document management system of claim 23 wherein the data management component (DMC) means further comprises a global knowledge manager for managing the data in the data repository (DR) means and a local knowledge manager for managing the information in the one or more data units in the data management component (DMC) means.
